(19) United States
(12) Patent Application Publication
(10) Pub. No.: US 2001/0048727 A1
(43) Pub. Date: Dec. 6, 2001

(54) Method and apparatus for automatic gain control on a time slot by time slot basis

(76) Inventors: Thomas R. Schmutz, Indialantic, FL (US); John R. Noll, Palm Bay, FL (US)

Correspondence Address: ROBERT J. SACCO, AKERMAN SENTERFITT & EIDSON, P.A., 222 Lakeview Avenue, Suite 400, P.O. Box 3188, West Palm Beach, FL, 33402-3188, US

(21) Appl. No.: 09/755,530

(22) Filed: Jan. 5, 2001

Related U.S. Application Data
(60) Provisional application No. 60/175,352, filed on Jan. 10, 2000.

(51) Int. Cl. H04J 3/00

(52) U.S. Cl. 375/345

(57) ABSTRACT

A method (150) of automatic gain control on a time slot by time slot basis in a base transceiver station (115) includes the steps of measuring (152) and storing (158) an amplitude of a signal on a given time slot for a predetermined number of prior time frames. Then, an appropriate gain adjustment factor for the given time slot is determined (166) and applied (168) to a received signal in a current time slot of the given time slot. Such application of the gain adjustment factor is applied on a time slot by time slot basis.

### CROSS REFERENCE TO RELATED APPLICATIONS

This application claims the benefit of U.S. Provisional Application No. 60/175,352 entitled, “NON-DELAYING PREDICTIVE WIDEBAND AGC CONTROL ON A TIME SLOT BY TIME SLOT BASIS,” filed Jan. 10, 2000, the entirety of which is incorporated herein by reference.

### STATEMENT REGARDING FEDERALLY SPONSORED RESEARCH OR DEVELOPMENT

(Not Applicable)

### BACKGROUND OF THE INVENTION

1. Field of the Invention

The invention generally relates to Time Division Multiple-Access (TDMA) cellular systems and more specifically to TDMA cellular systems having automatic gain control.

2. Description of Relevant Art

Time Division Multiple-Access (TDMA) cellular systems which require channel equalization typically impose the need for a linear receiver employing automatic gain control (AGC), conforming to stringent dynamic requirements. In a wideband transceiver, automatic gain control might be performed on a given bandwidth of 5 Megahertz (MHz) or more. In such an instance, it is difficult to perform AGC on received signals because the sampling rate of the received signals on which the AGC is based is too low at the high end of the 5 MHz bandwidth that is being sampled. The sampling rate is generally close to, or equivalent to the Nyquist sampling rate for the sampled bandwidth, resulting in an inaccurate representation of the sampled bandwidth. It further causes an unreliable attenuation of the waveform by the AGC. As a result of these effects, the AGC works differently depending on where in the bandwidth the transmission signal is located. Again, the closer the transmission signal gets to the upper level of the bandwidth, the less reliable gain control of the signal.

In some current base transceiver stations, attenuation is performed on the received transmission signals using a digital step attenuator that is controlled by logic existing in a channelizer of the base transceiver station (BTS). The AGC in such a BTS would typically instruct the attenuator to add or remove gain without reference to the burst timing of the transmission signal. This allows the attenuator to add or remove gain at any time, including during time slots. As a result of the lack of any restriction on the time at which attenuation could be performed on the transmission signal, the digital step attenuator in such BTS only has the ability to perform incremental additions of gain to a transmission signal over a time period. In the existing BTS, attenuation is varied only slowly over a period of time, except in the case of an extremely large signal being received by such BTS. This slow attenuation is performed in order to prevent large changes in signal level from occurring during a time slot, which can destroy, or make incomprehensible, the transmitted information. When an extremely large signal is received by the BTS, attenuation can be immediately added to this signal upon its receipt in order to lower that signal level into a range at which the analog-to-digital converter of the BTS ideally operates.

The problem with automatic gain control is further aggravated with wideband transceivers. In a wideband system, multiple RF channels might be present simultaneously in the transceiver. By attenuating one large signal, all other signals within the bandwidth are “punished” unintentionally. In other words, all slots on all RF carriers would be punished for one offending time slot on one carrier under existing AGC schemes for wideband transceivers. For example, a given bandwidth can have 12 RF carriers and 8 time slots per frame creating 96 physical channels. Thus, when one signal transmitted to the BTS is attenuated, the remaining 95 channels (mobiles) potentially transmitting to the BTS will be subject to attenuation as well. Again, this means that if one mobile transmits to the BTS at a power level requiring attenuation, then all of the mobiles sending information over the eight time slots of a time frame of the 12 RF carriers transmitting to the BTS must also be attenuated. Another problem with this uniform attenuation in the existing BTS is that once the AGC instructs this attenuation to be performed, there is no way to provide this attenuation information for inclusion in the determination of the Received Signal Strength Indicator (RSSI) value for each transmitting mobile. Without the inclusion of the attenuation information into this calculation, the existing RSSI calculations of the BTS could instruct mobiles to increase their transmitting signal strength unnecessarily. This increase in signal strength can result in premature battery failure, as well as the perpetuation of the need for the AGC to call for attenuation of mobile signals.

### SUMMARY OF THE INVENTION

In a first aspect of the present invention a method of automatic gain control on a time slot by time slot basis in a receiver module of a base transceiver station comprises the steps of measuring an amplitude of a signal on a given time slot among the plurality of time slots for a predetermined number of prior time frames to provide at least one amplitude value per given time slot and storing the at least one amplitude value and associated time slot information and determining an appropriate gain adjustment factor for the given time slot. The method further comprises the step of applying the gain adjustment factor to at least one received signal in a current time slot of the given time slot, wherein a respective gain adjustment factor for each given time slot is applied to a plurality of current time slots within the time frame on a time slot by time slot basis.

In another aspect of the present invention, an apparatus for controlling the amplitude of at least one currently received TDMA signal in a receiver module of a base transceiver station (BTS) employed in a time-division multiple access (TDMA) communication system comprises a receiver within the receiver module for receiving TDMA signals and a memory coupled to the receiver for storing amplitude values and associated time slot information determined from at least one previously received TDMA signal, the previously received TDMA signal arriving during at least one earlier frame. The apparatus also comprises a processor coupled to the memory and the receiver. The processor is preferably programmed to determine from the stored amplitude values and associated time slot information an appropriate gain adjustment factor for each of said plurality of time slots, to detect at least one currently received TDMA signal, and to apply respective appropriate gain adjustment factors to respective currently received TDMA signals.

### BRIEF DESCRIPTION OF THE DRAWINGS

Features and advantages of the present invention will become apparent to those skilled in the art from the following description with reference to the drawings, in which:

FIG. 1 is a block diagram of an exemplary base transceiver station in accordance with the present invention.

FIG. 2 is another block diagram illustrating a base transceiver station in accordance with the present invention.

FIG. 3 is a block diagram illustrating a receiver portion of the base transceiver station in accordance with the present invention.

FIG. 4 is a flow chart illustrating a method of automatic gain control in accordance with the present invention.

### DETAILED DESCRIPTION OF PREFERRED EMBODIMENTS

The drawbacks of the AGC described above in existing multi-carrier wideband base transceiver stations are overcome by the BTS of the present invention. In the BTS of the present invention, the AGC can be performed on a burst-by-burst basis. This means the number of mobiles (physical channels) that are affected by the AGC instructing the attenuation of a high power mobile is significantly reduced. In the example provided above, where a wideband multi-carrier TDMA system having 12 RF channels and 8 time slots per frame, the number of mobiles that are affected by the AGC instructing the attenuation of a high power mobile is reduced from 95 other mobiles to 11 other mobiles. These 11 other affected mobiles will be those mobiles in the 11 other RF channels transmitting to the BTS that are in the corresponding time slots as the high-power RF Channel 1 (time slot 2 for example), the mobiles transmitting in Time Slot 2 of RF Channels 2-12 will be attenuated along with the high power mobile. The mobiles in the remaining time slots should be unaffected.

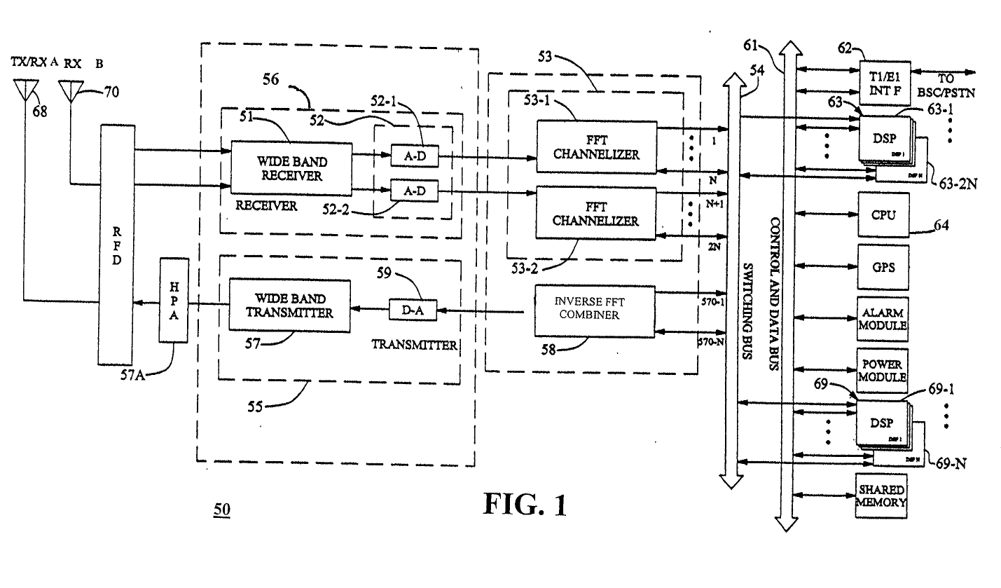

Referring to FIG. 1, a broadband BTS 50 is illustrated, which comprises a receiver section 56 and a transmitter section 55. It will be readily appreciated by those skilled in the art that the particular transceiver architecture shown is not critical. Accordingly, the invention disclosed herein is not intended to be so limited. Receiver section 56 preferably includes antennas 68, 70 and a wideband receiver 51 capable of receiving a plurality of carrier frequency channels. Signals from the received channels can include new power requests, power adjustment requests and traffic channel data from mobile users. The term “wideband,” as used herein, is not limited to any particular spectral range, and it should be understood to imply a spectral coverage of multiple frequency channels within the communication range over which a wireless communication system may operate (e.g. 5 MHz). Narrowband, on the other hand, implies a much smaller portion of the spectrum, for example, the width of an individual channel (e.g. 200 kHz).

The output of the wideband receiver 51 is downconverted into a multi-channel baseband signal that preferably contains the contents of all of the voice/data carrier frequency channels currently operative in the communication system or network of interest. This multi-channel baseband signal is preferably coupled to high speed A-D converters 52-1 and 52-2 operating in parallel for diversity receive capability. Where no diversity capability is required, a single A-D 52-1 could be utilized. Additionally, more than one parallel leg may be required for sectorized applications. Hence, it should readily be appreciated by one skilled in the art that the presence of a second parallel processing leg is not intended to be a limitation on the instant invention. The dynamic range and sampling rate capabilities of the A-D converter are sufficiently high (e.g. the sampling rate may be on the order of 25 Mega-samples per second (Msps)) to enable downstream digital signal processing (DSP) components, including Discrete Fourier Transform (DFT) channelizers 53-1 and 53-2, to process and output each of the active channels received by receiver 56.

The channelized outputs from the A-D converters are further processed to extract the individual channel components for each of the parallel streams. FFT channelizers 53-1 and 53-2 are preferably used to extract respective narrowband carrier frequency channel signals from the composite digitized multi-channel signals. These narrowband signals are representative of the contents of each of the respective individual carrier frequency communication channels received by the wideband receiver 51. The respective carrier frequency channel signals are coupled via a non-blocking switching bus to respective digital signal processing receiver units 63-1 . . . 63-N, each of which demodulates the received signal and performs any associated error correction processing embedded in the modulated signal. In the case where the received signals are destined for the PSTN, these demodulated signals derived from the digital signal processing receiver units 63 can be sent via a common shared bus 54 to a telephony carrier interface, for example, T1 carrier digital interface 62, of an attendant telephony network (not shown).

The transmitter section 55 includes a second plurality of digital signal processing units, specifically, transmitter digital signal processing units 69-1 . . . 69-N, that are coupled to receive from the telephony network respective ones of a plurality of channels containing digital voice/data communication signals to be transmitted over respectively different individual carrier frequency channels of the multi-channel network. Transmitter digital signal processing units 69 modulate and perform pre-transmission error correction processing on respective incoming communication signals, and supply processed carrier frequency channel signals over the common bus 54 to respective input ports of an inverse FFT-based multi-channel combiner unit 58. The combiner 58 outputs a composite multi-channel digital signal. This composite signal is representative of the contents of a wideband signal which contains the respective narrowband carrier frequency channel signals output from the digital signal processing transmitter units 69. A composite signal generated from the output of the multi-channel combiner unit 58 is then processed by the digital-to-analog (D-A) converter 59. The output of D-A converter 59 is coupled to a wideband (multi-channel) transmitter unit 57, which can include or have a separate multi-channel high power amplifier (HPA) 57A. The transmitter unit 57 transmits a wideband (multi-channel) communication channel signal defined by the composite signal output of the inverse fast Fourier transform-based combiner unit 58. The output of the HPA 57A is then coupled to antenna 68 for transmission.

A central processing unit (CPU) controller 64 is provided for coordinating and controlling the operation of BTS 50. For example, the CPU 64 can include a control processing unit, memory and suitable programming for responding to transmit power control requests received from mobile transceiver units. CPU 64 can preferably selectively control transmit power levels for each TDMA communication channel on a timeslot-by-timeslot basis. The CPU 64 may be a microprocessor, DSP processor, or micro controller having firmware, software or any combination thereof.

DSPs 63 can extract encoded information from each of the narrowband carrier frequency channel signals. Information for each of these channels can be stored in a memory such as shared memory 75 through the common control and data bus 61. The memory could also be flash memory within the DSP processors for example. CPU 64, under firmware and/or software control, can then access the shared memory 75 through bus 61. After the information for each channel in the received signal is processed and separated, DSPs 63 can store the control channel data in the shared memory 75. CPU 64 can then access shared memory 75 to retrieve the control channel data. CPU 64, under software and/or firmware control, can then use this data, for example, as an input to a control algorithm. The output from the algorithm can be stored in shared memory 75 for later use.

The invention described uses a GSM air-interface. However, this invention could also apply to other TDMA structures such as IS-136 and IS-54, or any other wireless protocol using time slots.

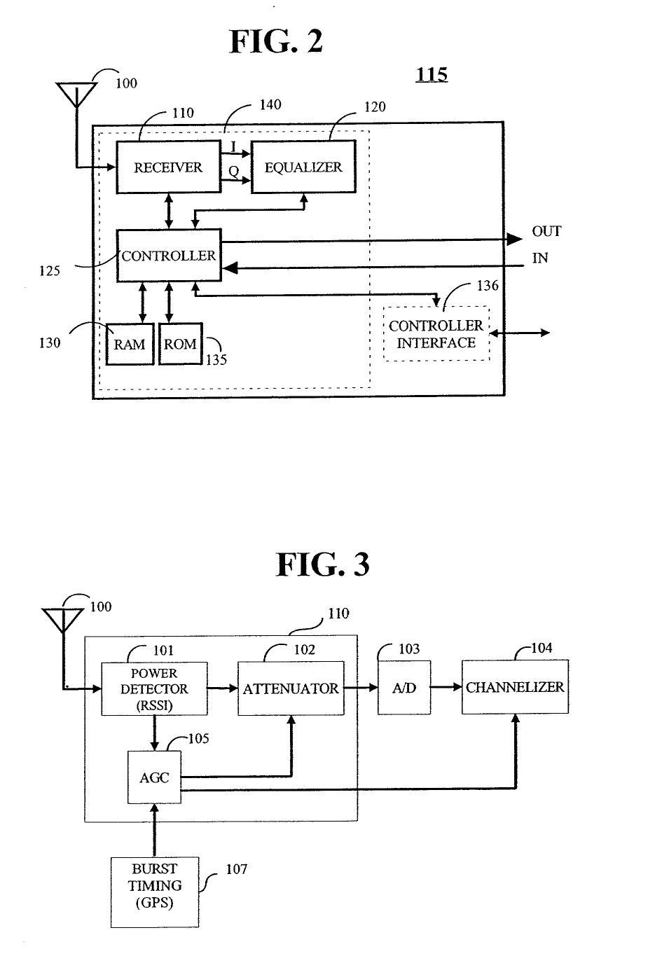

Referring to FIG. 2, base transceiver station 115 is shown in accordance with the present invention generally illustrating a receiver portion of the station that may employ the present invention. The signals that would be transmitted by mobile units in a single timeslot is received by an antenna 100. A receiver 110 receives these signals and will detect or demodulate each burst into an in-phase and quadrature phase (I & Q) components which are input into an equalizer 120. The receiver 110 in accordance with the present invention preferably receives TDMA signals. The receiver, as is the equalizer, is coupled to a controller 125 which may contain all the control hardware necessary to perform the AGC processing. The controller has a data-out port for sending data to additional devices and a data-in port for receiving data from additional devices. Memory such as RAM 130 is coupled to the receiver for storing amplitude values and associated time slot information determined from at least one previously received TDMA signal which may have arrived during at least one earlier frame. The controller or processor 125 is coupled to the memory and the receiver and further preferably programmed to determine from the stored amplitude values and associated time slot information an appropriate gain adjustment factor for each of the plurality of time slots. Additionally, the controller 125 should be programmed to detect at least one currently received TDMA signal and to apply respective appropriate gain adjustment factors to respective currently received TDMA signals.

A controller interface 136 which essentially allows the controller 125 to communicate to a user is optionally available, and in the preferred embodiment is typically connected to a PC. The controller 125 is coupled to a read only memory (ROM) 135 and a random access memory (RAM) 130. The receiver 110, equalizer 120, controller 125, RAM 130, and ROM 135 generally comprise a receiver module or radio channel unit (RCU) 140. The receiver front-end 105 is used to distribute the incoming signal to at least one RCU 140, depending on the configuration of the base-station 115.

Referring to FIG. 3, receiver 110 in accordance with the present invention also takes into account burst timing in performing attenuation on transmitted signals as shown. This means that the BTS attempts to, whenever possible, measure the power of a received signal using power detector 101 and perform variable attenuation using the attenuator 102 in the guard periods of a RF carrier transmission. The guard period is the time in between time slots in the RF carrier transmission in which no signal information is being transmitted. If attenuation of an RF carrier signal is performed in these guard periods, information transmitted in the time slots will not be substantially changed during their transmission and large signal level changes between guard periods and the information carrying signals in the times slot is avoided. As discussed above, large signal levels can overflow the analog-to-digital converter and cause all RF carriers during that timeslot to be undetectable. The performance of AGC in the guard periods of an RF carrier transmission in the BTS is preferably accomplished through the use of GPS timing information (107) that is provided to the AGC. This GPS timing information is the same information on which the time slot bursts of the RF carriers are based. Thus, ideally, the automatic gain control function is synchronous with the time slot burst. Of course, other means could be employed to synchronize the AGC function with the slot burst of the RF carriers.

The output of the receiver 110 is preferably downconverted into a multi-channel baseband signal that preferably contains the contents of all of the voice/data carrier frequency channels currently operative in the communication system or network of interest. This multi-channel baseband signal is preferably coupled to a high speed A-D converter 103 that has a dynamic range and sampling rate capability sufficiently high to enable downstream digital signal processing (DSP) components, including Discrete Fourier Transform (DFT) channelizer 104 to process and output each of the active channel received by receiver 110. The FFT channelizer 104 is preferably used to extract narrowband carrier frequency channel signals from the composite digitized multi-channel signals. These narrowband signals are representative of the contents of each of the respective individual carrier frequency communication channels received by the wideband receiver 110.

In order for AGC to be performed in the guard periods of the RF carrier transmission, the AGC cannot be performed based on the actual signal strength of the transmission occurring in the time slot sought to be attenuated. The AGC performed is predictive. The amount of attenuation or gain added to the signal transmitted during a time slot is based on an average of the strengths of signals received in that time slot in earlier time frames. This means that if a high signal was received in Time Slot 1 of Time Frame 1, then attenuation will be performed on the signal received in Time Slot 1 of Time Frame 2. In general, the BTS will store information concerning the received signal strengths for a time slot for the previous eight time frames, and will use this information in determining whether attenuation on the signal transmitted over that time slot is needed.

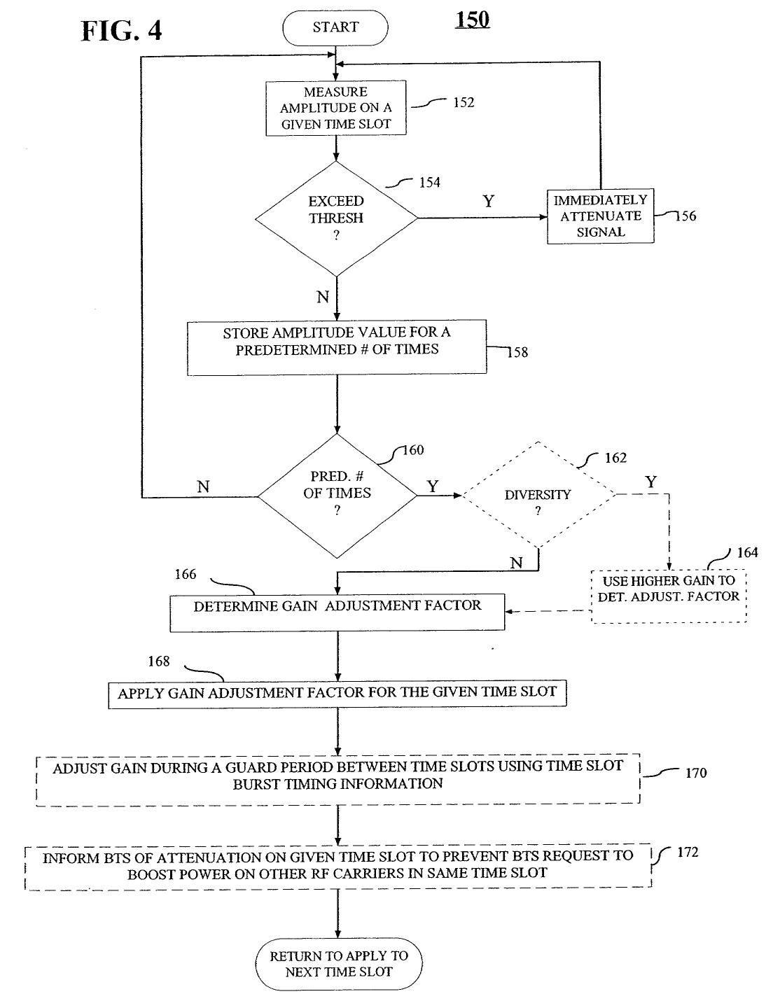

Referring to FIG. 4, a flowchart illustrating a method 150 of automatic gain control on a time slot by time slot basis in a receiver module of a base transceiver station is shown. Preferably, the method 150 is employed in a time-division multiple access (TDMA) communication system having a plurality of time slots within a time frame. The method begins by measuring an amplitude of a signal on a given time slot at step 152. The time slot is periodic and should be measured a predetermined number of prior time frames to provide at least one amplitude value per given time slot. However, even with this predictive AGC, the BTS of the present invention will still protect the analog-to-digital converter of the receiver. This means that upon the initial receipt by the BTS of an abnormally high signal strength exceeding a predetermined threshold as shown in decision block 154, that signal strength will be immediately attenuated at step 156—even during the time slot in which the signal is being transmitted. While this attenuation may result in the loss of information, the abnormally high signal strength can cause saturation in the BTS and a loss of information as a result anyway. Then in the next time frame, the attenuation will be performed on the offending time slot during the guard period prior to that time slot. As explained, the high strength signal should be immediately attenuated upon initial receipt notwithstanding the gain adjustment factor that may have been applied previously.

If the signal received does not exceed the threshold at decision block 154, then the amplitude value and associated time slot information is stored in a memory such as RAM 103 (see FIG. 2). As previously explained, a predetermined number of values are stored. Until the predetermined number of stored values is reached at decision block 160, the given time slot is measured until a predetermined number is reached to allow for a determination of a relatively accurate predictive gain adjustment factor in step 166 for a given time slot. Optionally, the method further comprises the step of determining if a diversity condition exists at decision block 162 where multiple received signals are received at distinct receive paths such as shown in FIG. 1 by using separate receive antennas 68 and 70. In such an instance, the determination of a gain adjustment factor should be based on a higher gain detected in such diversity condition as indicated in block 164. If no diversity condition exists at decision block 162, then an appropriate gain adjustment factor is determined as normal for the given time slot at step 166. Subsequently, the gain adjustment factor is applied at step 168 to at least one received signal in a current time slot of the given time slot, wherein a respective gain adjustment factor for each given time slot is applied to a plurality of current time slots within the time frame on a time slot by time slot basis. Optionally, the method 150 may further comprise the step 170 of adjusting the gain during a guard period between the plurality of time slots to avoid large changes in signal level between the guard period and the time slot carrying information. Another option comprises the step of informing a base station transceiver of attenuation occurring on a given time slot to prevent a base station request of boosted power for other RF carriers using the same time slot as shown at step 72. As explained before, this will avoid unnecessary transmissions by mobiles and ultimately increase their battery life.

FIG. 4 is reflective of a more specific embodiment of the present invention where a method for controlling the amplitude of at least one currently received TDMA signal in a receiver module of a base transceiver station (BTS) is employed in a time-division multiple access (TDMA) communication system. Again, amplitude values and associated time slot information are stored and determined from at least one previously received TDMA signal, where at least one previously received TDMA signal arriving during at least one earlier frame. Then an appropriate gain adjustment factor for each of said plurality of time slots is determined from the stored amplitude values and associated time slot information. Once a currently received TDMA signal is detected, appropriate gain adjustment factors are applied to respective ones of the currently received TDMA signals. The appropriate gain adjustment factors are applied exclusively to the currently received TDMA signals occupying the respective plurality of time slots. The method may also supply the appropriate gain adjustment factors to a signal processor (such as DSP 63) responsible for determining a received signal strength (RSSI) for each of the least one currently received TDMA signal, whereby the BTS may consider the gain adjustment factors in determining a signal power for a transmitting mobile to use. It should be noted that the appropriate gain adjustment factors can be determined in a variety of ways including by averaging amplitudes of the at least one previously received TDMA signal arriving during the at least one earlier frame.

Unlike in existing base transceiver stations, the AGC in the present invention can provide information to the BTS concerning the adding of attenuation to received transmissions. This can allow the BTS to take this added attenuation into account when evaluating the RSSI for each of the 11 other mobiles affected. Thus, the present invention has the ability to require transmitting mobiles to increase or reduce their signal strength more accurately, resulting in a longer battery life for the mobiles and a reduction of perpetual attenuation from the increasing of signal strength.

It should be understood that the examples and embodiments described herein are for illustrative purposes only and that various modifications or changes in light thereof will be suggested to persons skilled in the art and are to be included within the spirit and purview of this application. The invention can take other specific forms without departing from the spirit or essential attributes thereof for an indication of the scope of the invention.

We claim:

1. A method of automatic gain control on a time slot by time slot basis in a receiver module of a base transceiver station employed in a communication system having a plurality of time slots within a time frame, comprising the steps of:
measuring an amplitude of a signal on a given time slot among the plurality of time slots for a predetermined number of prior time frames to provide at least one amplitude value per given time slot;
storing the at least one amplitude value and associated time slot information and determining an appropriate gain adjustment factor for the given time slot; and
applying the gain adjustment factor to at least one received signal in a current time slot of the given time slot, wherein a respective gain adjustment factor for each given time slot is applied to a plurality of current time slots within the time frame on a time slot by time slot basis.

2. The method of claim 1, wherein the step of measuring further comprises the step of measuring the amplitude of a plurality of signals on a given time slot.

3. The method of claim 2, wherein the step of applying the gain adjustment factor further comprises the step of applying a respective gain adjustment factor for each given time slot across a plurality of radio frequency carriers occupying each given timeslot.

4. The method of claim 3, wherein the method further comprises the step of adjusting the gain during a guard period between the plurality of time slots to avoid modifying attenuation devices in a receive path of the receiver which may corrupt data on the plurality of radio frequency carriers in a given time slot and thereby corrupt information.

5. The method of claim 1, wherein the method further comprises the step of immediately attenuating high strength signals upon initial receipt and detection of the high strength signals notwithstanding the gain adjustment factor that may have been applied.

6. The method of claim 1, wherein the method further comprises the step of maintaining the automatic gain control synchronous with a time slot burst.

7. The method of claim 1, wherein the method further comprises the step of informing a base station transceiver of attenuation occurring on a given time slot to help obviate a base station request to reduce power for other strong RF carriers using the same time slot.

8. The method of claim 1, wherein the method further comprise the step of applying attenuation based on a higher gain detected in a diversity condition.

9. The method of claim 1, wherein the step of applying a gain adjustment factor comprises the step of adjusting an attenuator with reference to the burst timing of a received signal on the given time slot.

10. A method for controlling the amplitude of at least one currently received TDMA signal in a receiver module of a base transceiver station (BTS) employed in a time-division multiple access (TDMA) communication system, said TDMA system having a plurality of time slots; the method comprising:
storing amplitude values and associated time slot information determined from at least one previously received TDMA signal, said at least one previously received TDMA signal arriving during at least one earlier frame;
determining from said stored amplitude values and associated time slot information an appropriate gain adjustment factor for each of said plurality of time slots;
detecting said at least one currently received TDMA signal; and applying respective ones of said appropriate gain adjustment factors to respective ones of said at least one currently received TDMA signals, wherein said appropriate gain adjustment factors are applied exclusively to said currently received TDMA signals occupying respective ones of said plurality of time slots.

11. The method for controlling the amplitude of received TDMA signals of claim 10, wherein said gain adjustment factors are applied during a guard period of said at least one currently received TDMA signal.

12. The method for controlling the amplitude of received TDMA signals of claim 11, wherein GPS timing information is provided to said system to time synchronize application of said gain adjustment factors to said guard periods.

13. The method for controlling the amplitude of received TDMA signals of claim 10, further comprising the step of supplying the appropriate gain adjustment factors to a signal processor responsible for determining a received signal strength (RSSI) for each of the least one currently received TDMA signal, whereby the BTS may consider the gain adjustment factors in determining a signal power for a transmitting mobile to use.

14. The method for controlling the amplitude of received TDMA signals of claim 10, wherein the step of detecting further comprises comparing an amplitude of the at least one currently received TDMA signal to a predetermined saturation threshold.

15. The method for controlling the amplitude of received TDMA signals of claim 14, further comprising the step of applying an attenuation factor during a time slot of the at least one currently received TDMA signal if an amplitude of the at least one currently received TDMA signal exceeds the predetermined saturation threshold.

16. The method for controlling the amplitude of received TDMA signals of claim 10, wherein the appropriate gain adjustment factors are determined by averaging amplitudes of the at least one previously received TDMA signal arriving during the at least one earlier frame.

17. The method for controlling the amplitude of received TDMA signals of claim 16, wherein IF envelope power values constitute the amplitudes of the at least one previously received TDMA signal arriving during the at least one earlier frame.

18. The method for controlling the amplitude of received TDMA signals of claim 10, wherein said BTS is a broadband BTS providing cellular service using a plurality of RF carriers, further comprising applying respective ones of said appropriate gain adjustment factors to said at least one currently received TDMA signals occupying said plurality of RF carriers on said respective time slot.

19. An apparatus for controlling the amplitude of at least one currently received TDMA signal in a receiver module of a base transceiver station (BTS) employed in a time-division multiple access (TDMA) communication system, said TDMA system having a plurality of time slots, comprising:
a receiver within the receiver module for receiving TDMA signals;
a memory coupled to the receiver for storing amplitude values and associated time slot information determined from at least one previously received TDMA signal, the at least one previously received TDMA signal arriving during at least one earlier frame; and
a processor coupled to the memory and the receiver and further being programmed to determine from the stored amplitude values and associated time slot information an appropriate gain adjustment factor for each of said plurality of time slots, to detect at least one currently received TDMA signal, and to apply respective ones of the appropriate gain adjustment factors to respective ones of the at least one currently received TDMA signals, wherein the appropriate gain adjustment factors are applied exclusively to the currently received TDMA signals occupying respective ones of said plurality of time slots.

20. The apparatus of claim 19, wherein the TDMA signals are synchronized to GPS timing for time slot bursts of RF carriers.
